(19) United States
(12) Patent Application Publication
(10) Pub. No.: US 2013/0069852 A1
(43) Pub. Date: Mar. 21, 2013

(54) LIGHT-EMITTING COMPONENT DRIVING CIRCUIT AND RELATED PIXEL CIRCUIT AND APPLICATIONS

(71) Applicants: Wen-Tui Liao, Taichung City (TW); Wen-Chun Wang, Taichung City (TW); Hsi-Rong Han, Taichung City (TW); Chih-Hung Huang, Taichung City (TW)

(72) Inventors: Wen-Tui Liao, Taichung City (TW); Wen-Chun Wang, Taichung City (TW); Hsi-Rong Han, Taichung City (TW); Chih-Hung Huang, Taichung City (TW)

(73) Assignee: WINTEK CORPORATION, Taichung City (TW)

(21) Appl. No.: 13/607,811

(22) Filed: Sep. 10, 2012

(30) Foreign Application Priority Data
Sep. 19, 2011 (TW) 100133558
Jul. 20, 2012 (TW) 101126310

(51) Int. Cl. G09G 3/32

(52) U.S. Cl. 345/77

(57) ABSTRACT

A pixel circuit related to an organic light-emitting diode (OLED) is provided. When signals having appropriate operation waveforms are supplied, the circuit configuration (7T1C or 5T1C) of the pixel circuit keeps the current flowing through an OLED unaffected by the impact of IR drop on a power supply voltage Vdd (or mitigates the impact of the power supply voltage Vdd on the current) and prevents the current flowing through the OLED from changing with the Vth shift of a TFT for driving the OLED. Thereby, the luminance uniformity of an OLED display adopting the pixel circuit is greatly improved.

### CROSS-REFERENCE TO RELATED APPLICATION

This application claims the priority benefits of Taiwan application serial no. 100133558, filed on Sep. 19, 2011, and Taiwan application serial no. 101126310, filed on Jul. 20, 2012. The entirety of each of the above-mentioned patent applications is hereby incorporated by reference herein and made a part of specification.

### BACKGROUND OF THE INVENTION

1. Field of the Invention

The invention generally relates to a flat panel display technique, and more particularly, to a driving circuit of a self-emissive light-emitting component (for example, an organic light-emitting diode (OLED), but not limited thereto) and related pixel circuit and applications.

2. Description of Related Art

Semiconductor and display technologies have been quickly developed along with the swift advance of our multimedia society. Regarding displays, active matrix organic light emitting diode (AMOLED) display is one of the most adaptable displays in today's multimedia age thanks to its many characteristics such as unlimited viewing angle, low fabrication cost, high response speed (over 100 times of that of liquid crystal display (LCD)), low power consumption, self-emission, applicability to DC driving of portable machines, large working temperature range, light weight, and small and slim size in accordance to any hardware equipment. Thus, AMOLED display is very potential and may replace LCD as a next-generation flat panel display.

Presently, an AMOLED display panel may be fabricated through a low-temperature polysilicon (LTPS) thin film transistor (TFT) fabrication process or an amorphous silicon (a-Si) TFT fabrication process. The LTPS TFT fabrication process includes relatively more photomask processes therefore offers a high cost. Thus, presently, the LTPS TFT fabrication process is usually used for manufacturing small-sized and medium-sized display panels, while the a-Si TFT fabrication process is usually used for manufacturing large-sized display panels.

Generally speaking, in an AMOLED display panel fabricated through the LTPS TFT fabrication process, the TFTs in a pixel circuit may be P-type TFTs or N-type TFTs. Since P-type TFTs offer a very good driving capability in the conduction of positive voltages, most existing AMOLED display panels are implemented by using P-type TFTs. However, if an organic light-emitting diode (OLED) pixel circuit is implemented by using P-type TFTs, the current flowing through the OLED changes not only with the impact of IR drop on a power supply voltage Vdd but also with the Vth shift of the TFT for driving the OLED. As a result, the luminance uniformity of an OLED display is impaired.

### SUMMARY OF THE INVENTION

Accordingly, to improve the luminance uniformity of an organic light-emitting diode (OLED) display, an exemplary embodiment of the invention provides a light-emitting component driving circuit. The light-emitting component driving circuit includes a driving unit, a data storage unit, and a light-emitting control unit. The driving unit is coupled between a power supply voltage and a light-emitting component and includes a driving transistor. The driving unit controls a driving current flowing through the light-emitting component in a light enable phase. The data storage unit is coupled to the driving unit and includes a shift-compensation transistor and a storage capacitor coupled between the driving transistor and a reference potential. The data storage unit stores a data voltage and a threshold voltage of the shift-compensation transistor through the storage capacitor in a data-writing phase.

The light-emitting control unit is coupled between the driving unit and the light-emitting component. The light-emitting control unit conducts the driving current from the driving unit to the light-emitting component in the light enable phase. In the light enable phase, the driving unit generates the driving current flowing through the light-emitting component in response to a cross-voltage of the storage capacitor, and the driving current flowing through the light-emitting component is unaffected by a threshold voltage of the driving transistor in response to the storage of the threshold voltage of the shift-compensation transistor.

According to an exemplary embodiment of the invention, the data storage unit further stores the power supply voltage through the storage capacitor in the data-writing phase. Accordingly, in the light enable phase, the driving current flowing through the light-emitting component is further unaffected by the power supply voltage in response to the storage of the power supply voltage.

According to an exemplary embodiment of the invention, under the condition that the driving current flowing through the light-emitting component is unaffected by the threshold voltage of the driving transistor or the power supply voltage, the gate of the driving transistor is coupled to the first end of the storage capacitor and the gate and the source of the shift-compensation transistor, and the source of the driving transistor is coupled to the power supply voltage. Accordingly, the data storage unit further includes a writing transistor, a transmission transistor, and a coupling transistor. The gate of the writing transistor receives a write scan signal, the source of the writing transistor receives the data voltage, and the drain of the writing transistor is coupled to the second end of the storage capacitor. The gate of the transmission transistor receives the write scan signal, the source of the transmission transistor is coupled to the power supply voltage, and the drain of the transmission transistor is coupled to the drain of the shift-compensation transistor. The gate of the coupling transistor receives a light enable signal, the source of the coupling transistor is coupled to the second end of the storage capacitor, and the drain of the coupling transistor is coupled to the reference potential.

According to an exemplary embodiment of the invention, under the condition that the driving current flowing through the light-emitting component is unaffected by the threshold voltage of the driving transistor or the power supply voltage, the data storage unit further initializes the voltage on the first end of the storage capacitor in response to a reset scan signal in a reset phase. Accordingly, the data storage unit further includes a reset transistor. The gate and the source of the reset transistor are coupled with each other for receiving the reset scan signal, and the drain of the reset transistor is coupled to the first end of the storage capacitor.

According to an exemplary embodiment of the invention, under the condition that the driving current flowing through the light-emitting component is unaffected by the threshold voltage of the driving transistor or the power supply voltage, the light-emitting control unit includes a light-emitting control transistor. The gate of the light-emitting control transistor receives the light enable signal, and the source of the light-emitting control transistor is coupled to the drain of the driving transistor.

According to an exemplary embodiment of the invention, under the condition that the driving current flowing through the light-emitting component is unaffected by the threshold voltage of the driving transistor or the power supply voltage, the first terminal of the light-emitting component is coupled to the drain of the light-emitting control transistor, and the second terminal of the light-emitting component is coupled to the reference potential.

According to an exemplary embodiment of the invention, under the condition that the driving current flowing through the light-emitting component is unaffected by the threshold voltage of the driving transistor or the power supply voltage, the driving transistor, the shift-compensation transistor, the writing transistor, the reset transistor, the transmission transistor, the coupling transistor, and the light-emitting control transistor are all P-type transistors.

According to another exemplary embodiment of the invention, in the light enable phase, the impact of the power supply voltage on the driving current flowing through the light-emitting component is effectively reduced/mitigated/eased in response to the data voltage related to the power supply voltage.

According to an exemplary embodiment of the invention, under the condition that the driving current flowing through the light-emitting component is unaffected by the threshold voltage of the driving transistor and the impact of the power supply voltage on the driving current flowing through the light-emitting component is effectively reduced/mitigated/eased, the gate of the driving transistor is coupled to the first end of the storage capacitor and the gate and the source of the shift-compensation transistor, the source of the driving transistor is coupled to the power supply voltage, and the second end of the storage capacitor is directly coupled to the reference potential. Accordingly, the data storage unit further includes a writing transistor. The gate of the writing transistor receives a write scan signal, the source of the writing transistor receives the data voltage, and the drain of the writing transistor is coupled to the drain of the shift-compensation transistor.

According to an exemplary embodiment of the invention, under the condition that the driving current flowing through the light-emitting component is unaffected by the threshold voltage of the driving transistor and the impact of the power supply voltage on the driving current flowing through the light-emitting component is effectively reduced/mitigated/eased, the data storage unit further initializes the voltage on the first end of the storage capacitor in response to a reset scan signal in a reset phase. Accordingly, the data storage unit further includes a reset transistor. The gate and the source of the reset transistor are coupled with each other for receiving the reset scan signal, and the drain of the reset transistor is coupled to the first end of the storage capacitor.

According to an exemplary embodiment of the invention, under the condition that the driving current flowing through the light-emitting component is unaffected by the threshold voltage of the driving transistor and the impact of the power supply voltage on the driving current flowing through the light-emitting component is effectively reduced/mitigated/eased, the light-emitting control unit includes a light-emitting control transistor. The gate of the light-emitting control transistor receives a light enable signal, and the source of the light-emitting control transistor is coupled to the drain of the driving transistor.

According to an exemplary embodiment of the invention, under the condition that the driving current flowing through the light-emitting component is unaffected by the threshold voltage of the driving transistor and the impact of the power supply voltage on the driving current flowing through the light-emitting component is effectively reduced/mitigated/eased, the first terminal of the light-emitting component is coupled to the drain of the light-emitting control transistor, and the second terminal of the light-emitting component is coupled to the reference potential.

According to an exemplary embodiment of the invention, under the condition that the driving current flowing through the light-emitting component is unaffected by the threshold voltage of the driving transistor and the impact of the power supply voltage on the driving current flowing through the light-emitting component is effectively reduced/mitigated/eased, the driving transistor, the shift-compensation transistor, the writing transistor, the reset transistor, and the light-emitting control transistor are all P-type transistors.

According to an exemplary embodiment of the invention, under the condition that the driving current flowing through the light-emitting component is unaffected by the threshold voltage of the driving transistor and unaffected by the power supply voltage (or the impact of the power supply voltage on the driving current flowing through the light-emitting component is effectively reduced/mitigated/eased), the light-emitting component is an OLED, the first terminal of the light-emitting component is the anode of the OLED, and the second terminal of the light-emitting component is the cathode of the OLED. Accordingly, the light-emitting component driving circuit is an OLED driving circuit, and the OLED driving circuit sequentially enters the reset phase, the data-writing phase, and the light enable phase.

According to an exemplary embodiment of the invention, under the condition that the driving current flowing through the light-emitting component is unaffected by the threshold voltage of the driving transistor and unaffected by the power supply voltage (or the impact of the power supply voltage on the driving current flowing through the light-emitting component is effectively reduced/mitigated/eased), in the reset phase, the reset scan signal is enabled, and the write scan signal and the light enable signal are disabled. In the data-writing phase, the write scan signal is enabled, and the reset scan signal and the light enable signal are disabled. In the light enable phase, the light enable signal is enabled, and the reset scan signal and the write scan signal are disabled.

Another exemplary embodiment of the invention provides a pixel circuit having the light-emitting component driving circuit described above, and the pixel circuit is an OLED pixel circuit.

Yet another exemplary embodiment of the invention provides an OLED display panel having aforementioned OLED pixel circuit.

Still another exemplary embodiment of the invention provides an OLED display having aforementioned OLED display panel.

As described above, the invention provides an OLED pixel circuit. When signals having appropriate operation waveforms are supplied, the circuit configuration (7T1C or 5T1C) of the OLED pixel circuit keeps the current flowing through an OLED unaffected by the impact of IR drop on a power supply voltage Vdd (or mitigates the impact of the power supply voltage Vdd on the current) and prevents the current flowing through the OLED from changing with the Vth shift of a TFT for driving the OLED. Thereby, the luminance uniformity of an OLED display adopting the OLED pixel circuit is greatly improved.

These and other exemplary embodiments, features, aspects, and advantages of the invention will be described and become more apparent from the detailed description of exemplary embodiments when read in conjunction with accompanying drawings.

However, it should be understood that both foregoing general description and following detailed description are exemplary and are not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an organic light-emitting diode (OLED) pixel circuit 10 according to an exemplary embodiment of the invention.

FIG. 2 is a circuit diagram of the OLED pixel circuit 10 in FIG. 1.

FIG. 3 illustrates operation waveforms of the OLED pixel circuit 10 in FIG. 1.

FIG. 4 is a diagram of an OLED pixel circuit 10′ according to another exemplary embodiment of the invention.

FIG. 5 is a circuit diagram of the OLED pixel circuit 10′ in FIG. 4.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

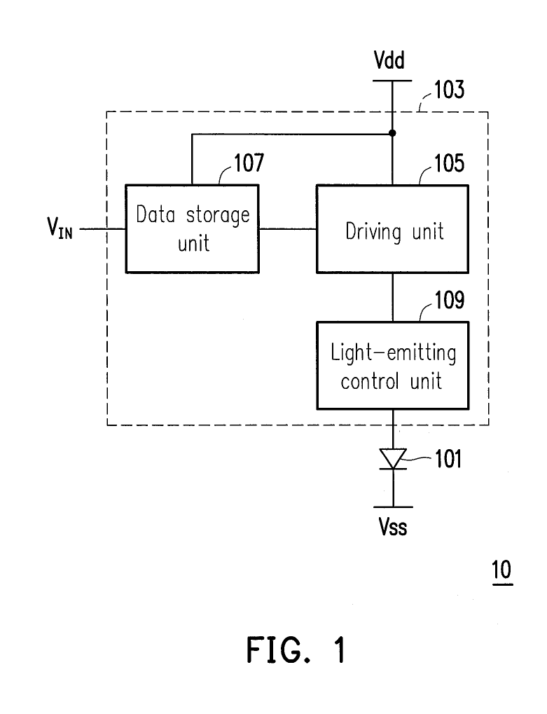

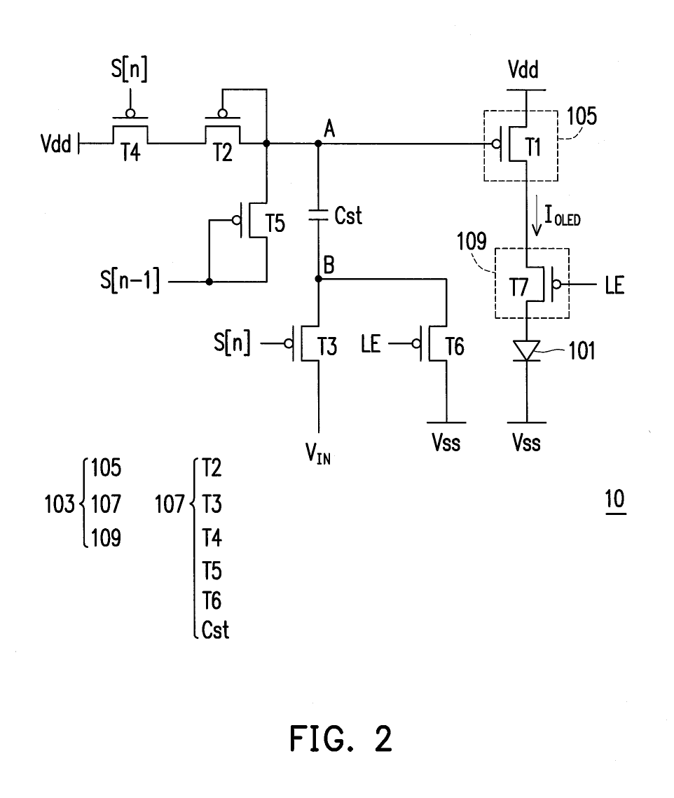

FIG. 1 is a diagram of a pixel circuit 10 according to an exemplary embodiment of the invention, and FIG. 2 is a circuit diagram of the pixel circuit 10 in FIG. 1. Referring to both FIG. 1 and FIG. 2, the pixel circuit 10 in the present exemplary embodiment includes a light-emitting component (for example, an organic light-emitting diode (OLED), but not limited thereto, accordingly the pixel circuit 10 can be considered as an OLED pixel circuit) 101 and a light-emitting component driving circuit 103. The light-emitting component driving circuit 103 includes a driving unit 105, a data storage unit 107, and a light-emitting control unit 109.

In the present exemplary embodiment, the driving unit 105 is coupled between a power supply voltage Vdd and the OLED (i.e., light-emitting component) 101 and includes a driving transistor T1. The driving unit 105 controls a driving current I_{OLED} flowing through the OLED 101 in a light enable phase.

The data storage unit 107 is coupled to the driving unit 105 and includes a shift-compensation transistor T2 and a storage capacitor Cst coupled between the driving transistor T1 and a reference potential Vss. Besides, the data storage unit 107 stores a data voltage V_{IN} and a threshold voltage (Vth(T2)) related to the shift-compensation transistor T2 through the storage capacitor Cst in a data-writing phase.

The data storage unit 107 initializes/resets the voltage on a first end of the storage capacitor Cst (i.e., voltage on node A) in response to a reset scan signal S[n−1] in a reset phase. Herein the reset scan signal S[n−1] is a signal on a previous scan line and is supplied by the [n−1]^{th} stage of gate driving circuit. However, the invention is not limited thereto.

The light-emitting control unit 109 is coupled between the driving unit 105 and the OLED (light-emitting component) 101. The light-emitting control unit 109 conducts the driving current I_{OLED} from the driving unit 105 to the OLED 101 in the light enable phase.

In the present exemplary embodiment, the driving unit 105 generates the driving current I_{OLED} flowing through the OLED 101 in response to the cross-voltage of the storage capacitor Cst in the light enable phase, and the driving current I_{OLED} is unaffected by the power supply voltage Vdd and the threshold voltage (Vth(T1)) of the driving transistor T1. In other words, the driving current I_{OLED} flowing through the OLED 101 is not related to the power supply voltage Vdd or the threshold voltage (Vₜₕ(T1)) of the driving transistor T1.

The data storage unit 107 further includes a writing transistor T3, a transmission transistor T4, a reset transistor T5, and a coupling transistor T6. Besides, the light-emitting control unit 109 includes a light-emitting control transistor T7.

In the present exemplary embodiment, the driving transistor T1, the shift-compensation transistor T2, the writing transistor T3, the transmission transistor T4, the reset transistor T5, the coupling transistor T6, and the light-emitting control transistor T7 are all P-type transistors (for example, P-type thin-film-transistors (TFT)). Besides, an OLED display panel adopting the OLED pixel circuit 10 illustrated in FIG. 2 may be fabricated through a low-temperature polysilicon (LTPS) TFT fabrication process, an amorphous silicon (a-Si) TFT fabrication process, or an a-IGZO TFT fabrication process. However, the invention is not limited thereto.

Additionally, in the circuit configuration (7T1C) of the OLED pixel circuit 10 illustrated in FIG. 2, the gate of the driving transistor T1 is coupled to the first end (i.e., node A) of the storage capacitor Cst and the gate and the source of the shift-compensation transistor T2, and the source of the driving transistor T1 is coupled to the power supply voltage Vdd.

The gate of the writing transistor T3 receives a write scan signal S[n] (herein the write scan signal S[n] may be a signal on the current scan line and supplied by the [n]^{th} stage of gate driving circuit, but not limited thereto), the source of the writing transistor T3 receives the data voltage V_{IN}, and the drain of the writing transistor T3 is coupled to the second end (i.e., node B) of the storage capacitor Cst.

The gate of the transmission transistor T4 receives the write scan signal S[n], the source of the transmission transistor T4 is coupled to the power supply voltage Vdd, and the drain of the transmission transistor T4 is coupled to the drain of the shift-compensation transistor T2. The gate and the source of the reset transistor T5 are coupled with each other for receiving the reset scan signal S[n−1], and the drain of the reset transistor T5 is coupled to the first end of the storage capacitor Cst.

The gate of the coupling transistor T6 receives a light enable signal LE, the source of the coupling transistor T6 is coupled to the second end of the storage capacitor Cst, and the drain of the coupling transistor T6 is coupled to the reference potential Vss. The gate of the light-emitting control transistor T7 receives the light enable signal LE, and the source of the light-emitting control transistor T7 is coupled to the drain of the driving transistor T1. The anode of the OLED 101 is coupled to the drain of the light-emitting control transistor T7, and the cathode of the OLED 101 is coupled to the reference potential Vss. In following embodiments, the reference potential Vss is assumed to be a zero potential (i.e., the ground potential) for the convenience of description. However, the invention is not limited thereto.

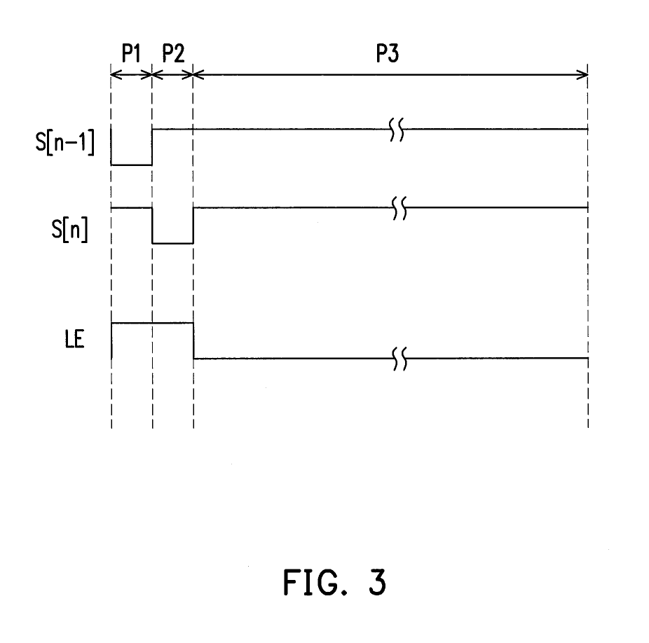

In the operation of the OLED pixel circuit 10 illustrated in FIG. 2, the light-emitting component driving circuit (i.e., OLED driving circuit) 103 sequentially enters the reset phase, the data-writing phase, and the light enable phase, as respectively denoted as P1, P2, and P3 in FIG. 3. In the present exemplary embodiment, in the reset phase P1, only the reset scan signal S[n−1] is enabled. In the data-writing phase P2, only the write scan signal S[n] is enabled. In the light enable phase P3, only the light enable signal LE is enabled.

In other words, in the reset phase P1, the reset scan signal S[n−1] is enabled, and the write scan signal S[n] and the light enable signal LE are disabled. In the data-writing phase P2, the write scan signal S[n] is enabled, and the reset scan signal S[n−1] and the light enable signal LE are disabled. In the light enable phase P3, the light enable signal LE is enabled, and the reset scan signal S[n−1] and the write scan signal S[n] are disabled. However, the high and low levels (VH, VL) of the reset scan signal S[n−1], the write scan signal S[n], and the light enable signal LE can be determined according to the actual design/application requirement.

It is noted that since the driving transistor T1, the shift-compensation transistor T2, the writing transistor T3, the transmission transistor T4, the reset transistor T5, the coupling transistor T6, and the light-emitting control transistor T7 in the OLED pixel circuit 10 illustrated in FIG. 2 are all P-type transistors, so the driving transistor T1, the shift-compensation transistor T2, the writing transistor T3, the transmission transistor T4, the reset transistor T5, the coupling transistor T6, and the light-emitting control transistor T7 are low active. Accordingly, aforementioned enabled state of the reset scan signal S[n−1], the write scan signal S[n], and the light enable signal LE means that the reset scan signal S[n−1], the write scan signal S[n], and the light enable signal LE are at a low level.

In the reset phase P1, since only the reset scan signal S[n−1] is enabled, the voltage on the node A (i.e., the gate voltage (Vg) of the driving transistor T1) is equal to the low level (VL_{S[n-1]}) of the reset scan signal S[n−1] minus Vₜₕ(T5) (i.e., VL_{S[n-1]}−Vₜₕ(T5)) in response to the turned-on of the diode-connected reset transistor T5. Herein Vₜₕ(T5) is the threshold voltage of the reset transistor T5. Meanwhile, since the light enable signal LE is disabled, the coupling transistor T6 and the light-emitting control transistor T7 are in a turned-off state, so that sudden brightening of the OLED 101 is prevented and accordingly the contrast of a displayed image is maintained. In addition, since the write scan signal S[n] is disabled, the writing transistor T3 and the transmission transistor T4 are also in the turned-off state.

In the data-writing phase P2, since only the write scan signal S[n] is enabled, the writing transistor T3 and the transmission transistor T4 are both in the turned-on state, and the diode-connected shift-compensation transistor T2 is also turned on. In this case, the power supply voltage Vdd is conducted to the first end (i.e., node A) of the storage capacitor Cst through the transmission transistor T4 and the diode-connected shift-compensation transistor T2, so that the voltage on the node A is equal to Vdd−Vₜₕ(T2). Herein Vₜₕ(T2) is the threshold voltage of the shift-compensation transistor T2. Meanwhile, the data voltage V_{IN} (herein it is assumed that V_{IN} is a grayscale display voltage Vdata corresponding to the pixel circuit 10 (i.e., V_{IN}=Vdata) but not limited thereto) is conducted to the second end (i.e., node B) of the storage capacitor Cst through the writing transistor T3, so that the voltage on the node B is equal to Vdata.

Thereby, in the data-writing phase P2, the voltage on the storage capacitor Cst is Vdd−Vₜₕ(T2)−Vdata. In other words, in the data-writing phase P2, the storage capacitor Cst stores information of the data voltage V_{IN} (Vdata), the threshold voltage Vₜₕ(T2) of the shift-compensation transistor T2, and the power supply voltage Vdd. Besides, in the data-writing phase P2, since the reset scan signal S[n−1] and the light enable signal LE are disabled, the reset transistor T5, the coupling transistor T6, and the light-emitting control transistor T7 are all in the turned-off state. Accordingly, the OLED 101 will not suddenly brighten up in the data-writing phase P2.

Eventually, in the light enable phase P3, since only the light enable signal LE is enabled, the shift-compensation transistor T2, the writing transistor T3, the transmission transistor T4, and the reset transistor T5 are in the turned-off state, and the driving transistor T1, the coupling transistor T6, and the light-emitting control transistor T7 are in the turned-on state. Accordingly, the driving transistor T1 generates the driving current I_{OLED} which is unaffected by the power supply voltage Vdd and the threshold voltage Vth(T1) of the driving transistor T1 and flows through the OLED 101 in response to the cross-voltage of the storage capacitor Cst.

To be specific, in the circuit configuration illustrated in FIG. 2, the driving current I_{OLED} generated by the driving transistor T1 in the light enable phase P3 can be expressed as following expression 1:

$${I}_{OLED} = \frac{1}{2} K \times {( Vsg - {V}_{th} ( T 1 ) )}^{2} . \qquad 1$$

In foregoing expression 1, K is a current constant related to the driving transistor T1.

In addition, the source-gate voltage (Vsg) of the driving transistor T1 is already known. Namely, the source voltage (Vs) of the driving transistor T1 is equal to Vdd (i.e., Vs=Vdd), the gate voltage (Vg) of the driving transistor T1 is equal to the voltage on the node A (i.e., Vg=Vdd−Vₜₕ(T2)-Vdata, herein the voltage on the node B is the zero potential (ground potential), and Vsg=Vs−Vg=Vdd−(Vdd−Vₜₕ(T2)−Vdata).

Thus, when the OLED pixel circuit 10 illustrated in FIG. 2 is in the light enable phase P3, following expression 2 is obtained by bringing the source-gate voltage (Vsg) of the driving transistor T1 into foregoing expression 1:

$${I}_{OLED} = \frac{1}{2} K \times {[ Vdd - ( Vdd - {V}_{th} ( T 2 ) - Vdata ) - {V}_{th} ( T 1 ) ]}^{2} , \qquad 2$$

Foregoing expression 2 can be further simplified into following expression 3:

$${I}_{OLED} = \frac{1}{2} K \times {( Vdata + {V}_{th} ( T2 ) - {V}_{th} ( T 1 ) )}^{2} . \qquad 3$$

Thereby, assuming that the threshold voltage Vth(T1) of the driving transistor T1 and the threshold voltage Vth(T2) of the shift-compensation transistor T2 are the same (i.e., Vₜₕ(T1)=Vₜₕ(T2)), the expression 3 can be further simplified into following expression 4:

$${I}_{OLED} = \frac{1}{2} K \times {( Vdata )}^{2} . \qquad 4$$

Obviously, the driving transistor T1 can generate the driving current I_{OLED} which is unaffected by the power supply voltage Vdd and the threshold voltage Vth(T1) of the driving transistor T1 in the light enable phase P3 by simply laying out the driving transistor T1 and the shift-compensation transistor T2 adjacent to each other and allowing the threshold voltage Vth(T1) of the driving transistor T1 and the threshold voltage Vth(T2) of the shift-compensation transistor T2 to be the same due to consistent crystallized state.

In other words, as indicated by expression 4, in the circuit configuration illustrated in FIG. 2, the driving current I_{OLED} flowing through the OLED 101 is not related to the power supply voltage Vdd or the threshold voltage Vth(T1) of the driving transistor T1 and is only related to the data voltage V_{IN} (Vdata). Thereby, any variation on the threshold voltage of a TFT caused by process factors can be compensated, and any change of the power supply voltage Vdd caused by IR drop can be compensated at the same time.

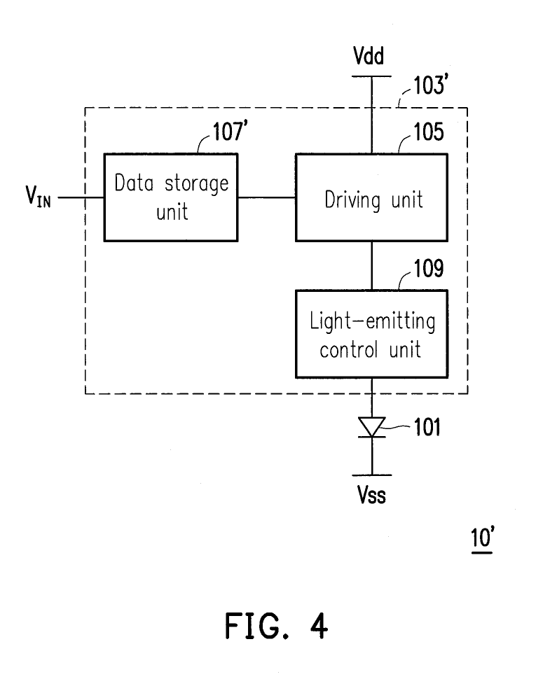

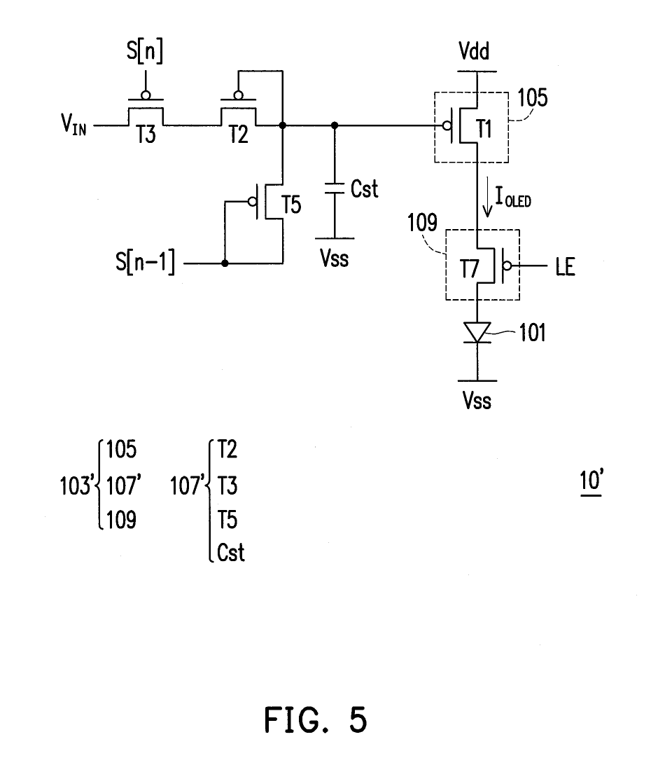

FIG. 4 is a diagram of an OLED pixel circuit 10′ according to another exemplary embodiment of the invention, and FIG. 5 is a circuit diagram of the OLED pixel circuit 10′ in FIG. 4. Referring to both FIG. 4 and FIG. 5, in the circuit configuration (5T1C) of the OLED pixel circuit 10′ illustrated in FIG. 5, the shift-compensation transistor T2, the writing transistor T3, the reset transistor T5 and the storage capacitor Cst are formed as the data storage unit 107′. The gate of the driving transistor T1 is coupled to the first end of the storage capacitor Cst and the gate and the source of the shift-compensation transistor T2, the source of the driving transistor T1 is coupled to the power supply voltage Vdd, and the second end of the storage capacitor Cst is (directly) coupled to the reference potential Vss (for example, the ground potential, but not limited thereto).

The gate of the writing transistor T3 receives the write scan signal S[n], the source of the writing transistor T3 receives the data voltage V_{IN} related to the power supply voltage Vdd (herein V_{IN} is assumed to be equal to Vdd−Vdata (i.e., V_{IN}=Vdd−Vdata), but not limited thereto), and the drain of the writing transistor T3 is coupled to the drain of the shift-compensation transistor T2. The gate and the source of the reset transistor T5 are coupled with each other for receiving the reset scan signal S[n−1], and the drain of the reset transistor T5 is coupled to the first end of the storage capacitor Cst.

The gate of the light-emitting control transistor T7 receives the light enable signal LE, and the source of the light-emitting control transistor T7 is coupled to the drain of the driving transistor T1. The anode of the OLED 101 is coupled to the drain of the light-emitting control transistor T7, and the cathode of the OLED 101 is coupled to the reference potential Vss (the ground potential).

Similarly, the driving transistor T1, the shift-compensation transistor T2, the writing transistor T3, the reset transistor T5, and the light-emitting control transistor T7 are all P-type transistors (for example, P-type TFTs). Besides, an OLED display panel adopting the OLED pixel circuit 10′ illustrated in FIG. 5 can be fabricated through a LTPS TFT fabrication process, an a-Si TFT fabrication process, or an a-IGZO TFT fabrication process. However, the invention is limited thereto.

In addition, in the operation of the OLED pixel circuit 10′ illustrated in FIG. 5, the light-emitting component driving circuit (i.e., OLED driving circuit) 103′ also sequentially enters the reset phase, the data-writing phase, and the light enable phase, as respectively indicated by P1, P2, and P3 in FIG. 3. In other words, the operation waveforms illustrated in FIG. 3 are also applicable to the circuit configuration illustrated in FIG. 5. Besides, the operation pattern of the OLED pixel circuit 10′ in FIG. 5 is similar to that of the OLED pixel circuit 10 in FIG. 2.

In the exemplary embodiment illustrated in FIG. 5, the driving unit 105 generates the driving current I_{OLED} flowing through the OLED 101 in response to the cross-voltage of the storage capacitor Cst in the light enable phase (P3). The driving current I_{OLED} is substantially unaffected by the threshold voltage Vₜₕ(T1) of the driving transistor T1, and the impact of the power supply voltage Vdd on the driving current I_{OLED} is effectively reduced/mitigated/eased. In other words, the driving current I_{OLED} flowing through the OLED 101 is not related to the threshold voltage Vₜₕ(T1) of the driving transistor T1 and is less or even not related to the power supply voltage Vdd.

To be specific, in the reset phase P1, since only the reset scan signal S[n−1] is enabled, the gate voltage (Vg) of the driving transistor T1 is equal to the low level (VL_{S[n-1]}) of the reset scan signal S[n−1] minus Vₜₕ(T5) (i.e., VL_{S[n-1]}−Vₜₕ(T5)) in response to the turned-on of the diode-connected reset transistor T5. Herein Vₜₕ(T5) is the threshold voltage of the reset transistor T5. Meanwhile, since the light enable signal LE is disabled, the light-emitting control transistor T7 is in the turned-off state so that sudden brightening of the OLED 101 is prevented and accordingly the contrast of a displayed image is maintained. In addition, since the write scan signal S[n] is disabled, the writing transistor T3 is also in the turned-off state.

In the data-writing phase P2, since only the write scan signal S[n] is enabled, the writing transistor T3 is in the turned-on state, and the diode-connected shift-compensation transistor T2 is also turned on. In this case, the data voltage V_{IN} (V_{IN}=Vdd−Vdata, but not limited thereto) is conducted to the storage capacitor Cst through the writing transistor T3 and the diode-connected shift-compensation transistor T2, so that the gate voltage (Vg) of the driving transistor T1 is equal to Vdd−Vdata−Vₜₕ(T2).

Thereby, in the data-writing phase P2, the storage capacitor Cst stores information of the data voltage V_{IN} (Vdd−Vdata) related to the power supply voltage Vdd and the threshold voltage Vₜₕ(T2) of the shift-compensation transistor T2. Besides, in the data-writing phase P2, since the reset scan signal S[n−1] and the light enable signal LE are disabled, the reset transistor T5 and the light-emitting control transistor T7 are both turned off. Accordingly, the OLED 101 does not suddenly brighten up in the data-writing phase P2.

In the light enable phase P3, since only the light enable signal LE is enabled, the shift-compensation transistor T2, the writing transistor T3, and the reset transistor T5 are all in the turned-off state, and the driving transistor T1 and the light-emitting control transistor T7 are in the turned-on state. Accordingly, the driving transistor T1 generates the driving current I_{OLED} flowing through the OLED 101 in response to the cross-voltage of the storage capacitor Cst. The driving current I_{OLED} is completely unaffected by the threshold voltage Vₜₕ(T1) of the driving transistor T1, and the impact of the power supply voltage Vdd (which changes with IR drop) on the driving current I_{OLED} is effectively mitigated.

To be specific, in the circuit configuration illustrated in FIG. 5, the driving current I_{OLED} generated by the driving transistor T1 in the light enable phase P3 can be expressed as following expression 5:

$${I}_{OLED} = \frac{1}{2} K \times {( Vsg - {V}_{th} ( T 1 ) )}^{2} . \qquad 5$$

In foregoing expression 5, K is a current constant related to the driving transistor T1.

Additionally, the source-gate voltage (Vsg) of the driving transistor T1 is also known. Namely, the source voltage (Vs) of the driving transistor T1 is equal to Vdd (i.e., Vs=Vdd), the gate voltage (Vg) of the driving transistor T1 is equal to Vdd−Vdata−Vₜₕ(T2) (i.e., Vg=Vdd−Vdata−Vₜₕ(T2)), and Vsg=Vs−Vg=Vdd−(Vdd−Vdata−Vₜₕ(T2)).

Obviously, in the OLED pixel circuit 10′ illustrated in FIG. 5, the source voltage (Vs) of the driving transistor T1 is equal to the highest level of the power supply voltage Vdd (denoted as VH_{Vdd}). Besides, in the pixel circuit 10′ illustrated in FIG. 5, the gate voltage (Vg) of the driving transistor T1 is equal to Vdd−Vdata−Vₜₕ(T2), where “Vdd” is the high voltage level in the data voltage V_{IN} that is related to the power supply voltage Vdd (denoted as VH_{VIN}).

In practice, since the power supply voltage Vdd and the data voltage V_{IN} (Vdd−Vdata) are different in circuit layout, VH_{Vdd}−VH_{VIN} is substantially not equal to zero (ideally should be equal to zero). Accordingly, the driving current I_{OLED} generated by the driving transistor T1 in FIG. 5 may be affected by any change of the power supply voltage Vdd caused by IR (current/resistance) drop.

However, if the impact of IR drop on the highest level VH_{Vdd} of the power supply voltage Vdd is made substantially equal to the impact of RC (resistance/capacitance) loading effect on the high voltage level VH_{VIN} related to the power supply voltage Vdd in the data voltage V_{IN} (Vdd−Vdata) (i.e., VH_{Vdd}−VH_{VIN} is substantially zero, but not limited thereto) through an appropriate layout design, the impact of the power supply voltage Vdd (which changes in response to IR drop) on the driving current I_{OLED} generated by the driving transistor T1 in FIG. 5 can be effectively mitigated.

In following description, it is assumed that VH_{Vdd}≈VH_{VIN}, such that when the OLED pixel circuit 10′ in FIG. 5 is in the light enable phase P3, following expression 6 is obtained by bringing the source-gate voltage (Vsg) of the driving transistor T1 into foregoing expression 5:

$${I}_{OLED} = \frac{1}{2} K \times {[ {VH}_{Vdd} - ( {VH}_{VIN} - Vdata - {V}_{th} ( T 2 ) ) - {V}_{th} ( T 1 ) ]}^{2} . \qquad 6$$

Foregoing expression 6 can be simplified into following expression 7:

$${I}_{OLED} = \frac{1}{2} K \times {[ ( {VH}_{Vdd} - {VH}_{VIN} ) + Vdata + {V}_{th} ( T 2 ) - {V}_{th} ( T 1 ) ]}^{2} . \qquad 7$$

However, if the highest level VH_{Vdd} of the power supply voltage Vdd and the high voltage level VH_{VIN} related to the power supply voltage Vdd in the data voltage V_{IN} (Vdd−Vdata) are designed to be substantially equal to each other (i.e., VH_{Vdd}=VH_{VIN}), foregoing expression 7 can be further simplified into following expression 8:

$${I}_{OLED} = \frac{1}{2} K \times {( Vdata + {V}_{th} ( T 2 ) - {V}_{th} ( T 1 ) )}^{2} . \qquad 8$$

Thereby, if the threshold voltage Vth(T1) of the driving transistor T1 is assumed to be equal to the threshold voltage Vth(T2) of the shift-compensation transistor T2 (i.e., Vₜₕ(T1)=Vₜₕ(T2)), foregoing expression 8 can be further simplified into following expression 9:

$${I}_{OLED} = \frac{1}{2} K \times {( Vdata )}^{2} . \qquad 9$$

Obviously, the driving transistor T1 in FIG. 5 can generate the driving current I_{OLED} which is substantially unaffected by the threshold voltage Vₜₕ(T1) of the driving transistor T1 in the light enable phase P3 by simply laying out the driving transistor T1 and the shift-compensation transistor T2 adjacent to each other and allowing the threshold voltage Vth(T1) of the driving transistor T1 and the threshold voltage Vth(T2) of the shift-compensation transistor T2 to be the same due to consistent crystallized state. The impact of the power supply voltage Vdd (which changes in response to IR drop) on the driving current I_{OLED} is effectively mitigated (if VH_{Vdd} is not equal to VH_{VIN}). Even, the driving current I_{OLED} may even be completely unaffected by the power supply voltage Vdd that changes in response to IR drop (if VH_{Vdd} is equal to VH_{VIN}).

In other words, as clearly indicated by foregoing expression 9, in the circuit configuration illustrated in FIG. 5, the driving current I_{OLED} flowing through the OLED 101 is substantially unrelated to the power supply voltage Vdd and the threshold voltage Vₜₕ(T1) of the driving transistor T1 and is only related to the data voltage Vdata. Thereby, any variation on the threshold voltage of a TFT caused by process factors can be compensated, and any change of the power supply voltage Vdd caused by IR drop can be compensated at the same time. Obviously, the circuit configuration illustrated in FIG. 5 can achieve similar technical effects as that of the circuit configuration in the exemplary embodiment illustrated in FIG. 2.

Accordingly, the circuit configurations of the OLED pixel circuits 10/10′ described in foregoing exemplary embodiments are respectively 7T1C (i.e., 7 TFTs and 1 capacitor, as shown in FIG. 2) and 5T1C (i.e., 5 TFTs and 1 capacitor, as shown in FIG. 4). When signals having appropriate operation waveforms are supplied (as shown in FIG. 3), the driving current I_{OLED} flowing through the OLED 101 does not change with the power supply voltage Vdd (which changes in response to IR drop) or the Vth shift of the driving transistor T1 for driving the OLED 101. Thus, the luminance uniformity of an OLED display adopting the OLED pixel circuit can be greatly improved.

In addition, any OLED display panel adopting the OLED pixel circuit 10/10′ in foregoing exemplary embodiments and an OLED display thereof are within the scope of the invention.

Moreover, even though all the transistors of the OLED pixel circuit in each exemplary embodiment described above are P-type transistors, the invention is not limited thereto. In other words, one person having ordinary skill in the art can implement the OLED pixel circuit disclosed in the invention by using N-type transistors based on the descriptions of foregoing exemplary embodiments, and such varied embodiments are also within the scope of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

Additionally, any embodiment or claim of the invention is not expected to achieve all aspects, advantages, or characteristics disclosed by the invention. Moreover, the abstract and title of the disclosure are intended for patent search but not intended to limit the scope of the invention.

What is claimed is:

1. A light-emitting component driving circuit, comprising:
a driving unit, coupled between a power supply voltage and a light-emitting component, comprising a driving transistor, and controlling a driving current flowing through the light-emitting component in a light enable phase;
a data storage unit, coupled to the driving unit, comprising a shift-compensation transistor and a storage capacitor coupled between the driving transistor and a reference potential, and storing a data voltage and a threshold voltage of the shift-compensation transistor through the storage capacitor in a data-writing phase; and
a light-emitting control unit, coupled between the driving unit and the light-emitting component, and conducting the driving current from the driving unit to the light-emitting component in the light enable phase,
wherein in the light enable phase, the driving unit generates the driving current flowing through the light-emitting component in response to a cross-voltage of the storage capacitor, and the driving current is unaffected by a threshold voltage of the driving transistor in response to the storage of the threshold voltage of the shift-compensation transistor.

2. The light-emitting component driving circuit according to claim 1, wherein the data storage unit further stores the power supply voltage through the storage capacitor in the data-writing phase,
wherein in the light enable phase, the driving current is further unaffected by the power supply voltage in response to the storage of the power supply voltage.

3. The light-emitting component driving circuit according to claim 2, wherein a gate of the driving transistor is coupled to a first end of the storage capacitor and a gate and a source of the shift-compensation transistor, and a source of the driving transistor is coupled to the power supply voltage,
wherein the data storage unit further comprises:
a writing transistor, having a gate for receiving a write scan signal, a source for receiving the data voltage, and a drain coupled to a second end of the storage capacitor;
a transmission transistor, having a gate for receiving the write scan signal, a source coupled to the power supply voltage, and a drain coupled to a drain of the shift-compensation transistor; and
a coupling transistor, having a gate for receiving a light enable signal, a source coupled to the second end of the storage capacitor, and a drain coupled to the reference potential,
wherein the data storage unit further initializes a voltage on the first end of the storage capacitor in response to a reset scan signal in a reset phase, and the data storage unit further comprises:
a reset transistor, having a gate and a source coupled with each other for receiving the reset scan signal and a drain coupled to the first end of the storage capacitor.

4. The light-emitting component driving circuit according to claim 3, wherein the light-emitting control unit comprises:
a light-emitting control transistor, having a gate for receiving the light enable signal and a source coupled to a drain of the driving transistor,
wherein a first terminal of the light-emitting component is coupled to a drain of the light-emitting control transistor, and a second terminal of the light-emitting component is coupled to the reference potential,
wherein the driving transistor, the shift-compensation transistor, the writing transistor, the reset transistor, the transmission transistor, the coupling transistor, and the light-emitting control transistor are all P-type transistors,
wherein the light-emitting component is an organic light-emitting diode (OLED), the first terminal of the light-emitting component is an anode of the OLED, and the second terminal of the light-emitting component is a cathode of the OLED.

5. The light-emitting component driving circuit according to claim 4, wherein the light-emitting component driving circuit is an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

6. The light-emitting component driving circuit according to claim 1, wherein in the light enable phase, an impact of the power supply voltage on the driving current is mitigated in response to the data voltage related to the power supply voltage.

7. The light-emitting component driving circuit according to claim 6, wherein a gate of the driving transistor is coupled to a first end of the storage capacitor and a gate and a source of the shift-compensation transistor, a source of the driving transistor is coupled to the power supply voltage, and a second end of the storage capacitor is coupled to the reference potential,
wherein the data storage unit further comprises:
a writing transistor, having a gate for receiving a write scan signal, a source for receiving the data voltage, and a drain coupled to a drain of the shift-compensation transistor,
wherein the data storage unit further initializes a voltage on the first end of the storage capacitor in response to a reset scan signal in a reset phase, and the data storage unit further comprises:
a reset transistor, having a gate and a source coupled with each other for receiving the reset scan signal and a drain coupled to the first end of the storage capacitor.

8. The light-emitting component driving circuit according to claim 7, wherein the light-emitting control unit comprises:
a light-emitting control transistor, having a gate for receiving a light enable signal and a source coupled to a drain of the driving transistor,
wherein a first terminal of the light-emitting component is coupled to a drain of the light-emitting control transistor, and a second terminal of the light-emitting component is coupled to the reference potential,
wherein the driving transistor, the shift-compensation transistor, the writing transistor, the reset transistor, and the light-emitting control transistor are all P-type transistors,
wherein the light-emitting component is an OLED, the first terminal of the light-emitting component is an anode of the OLED, and the second terminal of the light-emitting component is a cathode of the OLED.

9. The light-emitting component driving circuit according to claim 8, wherein the light-emitting component driving circuit is an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

10. A pixel circuit, comprising:
a light-emitting component, emitting light in response to a driving current in a light enable phase;
a driving unit, coupled between a power supply voltage and the light-emitting component, comprising a driving transistor, and controlling the driving current flowing through the light-emitting component in the light enable phase;
a data storage unit, coupled to the driving unit, comprising a shift-compensation transistor and a storage capacitor coupled between the driving transistor and a reference potential, and storing a data voltage and a threshold voltage of the shift-compensation transistor through the storage capacitor in a data-writing phase; and
a light-emitting control unit, coupled between the driving unit and the light-emitting component, and conducting the driving current from the driving unit to the light-emitting component in the light enable phase,
wherein in the light enable phase, the driving unit generates the driving current flowing through the light-emitting component in response to a cross-voltage of the storage capacitor, and the driving current is unaffected by a threshold voltage of the driving transistor in response to the storage of the threshold voltage of the shift-compensation transistor.

11. The pixel circuit according to claim 10, wherein the data storage unit further stores the power supply voltage through the storage capacitor in the data-writing phase,
wherein in the light enable phase, the driving current is further unaffected by the power supply voltage in response to the storage of the power supply voltage.

12. The pixel circuit according to claim 11, wherein a gate of the driving transistor is coupled to a first end of the storage capacitor and a gate and a source of the shift-compensation transistor, and a source of the driving transistor is coupled to the power supply voltage,
wherein the data storage unit further comprises:
a writing transistor, having a gate for receiving a write scan signal, a source for receiving the data voltage, and a drain coupled to a second end of the storage capacitor;
a transmission transistor, having a gate for receiving the write scan signal, a source coupled to the power supply voltage, and a drain coupled to a drain of the shift-compensation transistor; and
a coupling transistor, having a gate for receiving a light enable signal, a source coupled to the second end of the storage capacitor, and a drain coupled to the reference potential,
wherein the data storage unit further initializes a voltage on the first end of the storage capacitor in response to a reset scan signal in a reset phase, and the data storage unit further comprises:
a reset transistor, having a gate and a source coupled with each other for receiving the reset scan signal and a drain coupled to the first end of the storage capacitor.

13. The pixel circuit according to claim 12, wherein the light-emitting control unit comprises:
a light-emitting control transistor, having a gate for receiving the light enable signal and a source coupled to a drain of the driving transistor,
wherein a first terminal of the light-emitting component is coupled to a drain of the light-emitting control transistor, and a second terminal of the light-emitting component is coupled to the reference potential,
wherein the driving transistor, the shift-compensation transistor, the writing transistor, the reset transistor, the transmission transistor, the coupling transistor, and the light-emitting control transistor are all P-type transistors,
wherein the light-emitting component is an OLED, the first terminal of the light-emitting component is an anode of the OLED, and the second terminal of the light-emitting component is a cathode of the OLED,
wherein the pixel circuit is an OLED pixel circuit,
wherein the driving unit, the data storage unit, and the light-emitting control unit form an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

14. The pixel circuit according to claim 10, wherein in the light enable phase, an impact of the power supply voltage on the driving current is mitigated in response to the data voltage related to the power supply voltage.

15. The pixel circuit according to claim 14, wherein a gate of the driving transistor is coupled to a first end of the storage capacitor and a gate and a source of the shift-compensation transistor, a source of the driving transistor is coupled to the power supply voltage, and a second end of the storage capacitor is coupled to the reference potential,
wherein the data storage unit further comprises:
a writing transistor, having a gate for receiving a write scan signal, a source for receiving the data voltage, and a drain coupled to a drain of the shift-compensation transistor,
wherein the data storage unit further initializes a voltage on the first end of the storage capacitor in response to a reset scan signal in a reset phase, and the data storage unit further comprises:
a reset transistor, having a gate and a source coupled with each other for receiving the reset scan signal and a drain coupled to the first end of the storage capacitor.

16. The pixel circuit according to claim 15, wherein the light-emitting control unit comprises:
a light-emitting control transistor, having a gate for receiving a light enable signal and a source coupled to a drain of the driving transistor,
wherein a first terminal of the light-emitting component is coupled to a drain of the light-emitting control transistor, and a second terminal of the light-emitting component is coupled to the reference potential,
wherein the driving transistor, the shift-compensation transistor, the writing transistor, the reset transistor, and the light-emitting control transistor are all P-type transistors,
wherein the light-emitting component is an OLED, the first terminal of the light-emitting component is an anode of the OLED, and the second terminal of the light-emitting component is a cathode of the OLED,
wherein the pixel circuit is an OLED pixel circuit,
wherein the driving unit, the data storage unit, and the light-emitting control unit form an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

17. An OLED display panel comprising the pixel circuit as claimed in claim 13.

18. An OLED display comprising the OLED display panel as claimed in claim 17.

19. An OLED display panel comprising the pixel circuit as claimed in claim 16.

20. An OLED display comprising the OLED display panel as claimed in claim 19.
